(19) United States
(12) Patent Application Publication
(10) Pub. No.: US 2015/0097731 A1
(43) Pub. Date: Apr. 9, 2015

(54) GPS/WIFI INDOOR/OUTDOOR DETECTION

(71) Applicant: MOTOROLA MOBILITY LLC, LIBERTYVILLE, IL (US)

(72) Inventor: Michael E. Russell, Lake Zurich, IL (US)

(21) Appl. No.: 14/055,905

(22) Filed: Oct. 17, 2013

Related U.S. Application Data
(60) Provisional application No. 61/886,327, filed on Oct. 3, 2013.

(51) Int. Cl. G01S 1/08

(52) U.S. Cl. CPC G01S 1/08
USPC 342/450

(57) ABSTRACT

A portable communication device and method provide for determining indoor or outdoor location of the device. The method includes measuring a signal strength of at least one of a location service signal, a RAN signal, and a small coverage area signal that is detectable within a current location of the portable communication device, comparing signal strength to corresponding pre-established signal strength threshold, and obtaining contextual information by accessing sensor data from at least one sensor selected based on a result of the comparing. The method also includes configuring the portable communication device for operation within an outdoor space in response to determining that the portable communication device is transitioning from the indoor space to the outdoor space and configuring the portable device for operation within an indoor space in response to determining the portable device is transitioning from the outdoor space to the indoor space.

### BACKGROUND

1. Technical Field

The present disclosure generally relates to location and data services on a portable communication device, and more particularly to detecting whether the portable communication device is indoors or outdoors to appropriately configure location and data services.

2. Description of the Related Art

Personal electronic devices such as smart phones are becoming ubiquitous, providing a constant source of entertainment, communication, navigation, and personal assistance. Some of these functions depend upon determining the location of a portable communication device. Outside location services such as by receiving signals from Global Navigation Satellite System (GNSS) satellites can give such location and motion information, although with an increase in power consumption. GNSS is generally not accessible indoors nor is there typically a need for such location services indoors. Similarly, the portable communication device in many instances is multimode with regard to accessing data service. Certain multimode portable communication devices can access small coverage area devices or systems, such as WiFi devices and cellular femtocells, when indoors and can access wireless wide area networks (WWAN), such as cellular radio access networks (RAN), when outdoors. Configuring the portable communication device for efficient power consumption, data service, and location service functionality can thus depend on accurately determining whether the device is in an indoor space or an outdoor space.

### BRIEF DESCRIPTION OF THE DRAWINGS

The description of the illustrative embodiments is to be read in conjunction with the accompanying drawings, wherein:

FIG. 1 provides a block diagram representation of an example communication device, according to one embodiment;

FIG. 2 provides a detailed block diagram representation of an example communication device configured with various components that enable one or more described features of the disclosure, according to one embodiment;

FIG. 3 provides a top view diagram of the example communication device of FIG. 2 in certain illustrative contexts;

FIG. 4 provides a data structure table that maps the certain illustrative contexts of FIG. 3 to contextual data;

FIG. 5 provides a state diagram representation of states of the example communication device of FIG. 2;

FIG. 6 is a flow chart illustrating a method covering an aspect of indoor/outdoor detection, according to one or more embodiments.

FIG. 7 is a flow chart of an example method of using indoor and outdoor determination according to at least one embodiment;

FIG. 8 is a flow chart of another example method of using indoor and outdoor location determination according to at least one embodiment;

FIG. 9 is a flow chart of an additional example method of using indoor and outdoor location determination according to at least one embodiment; and

FIG. 10 a flow chart of is a further example method of using indoor and outdoor location determination according to at least one embodiment.

### DETAILED DESCRIPTION

The illustrative embodiments of the present disclosure provide a method and portable communication device for determining indoor or outdoor location of the device. According to one aspect, a method includes measuring signal strength and if applicable, a number of sources, of at least one of a location service signal, a radio access network (RAN) signal, and a small coverage area signal that is detectable within a current location of the portable communication device. The method includes comparing the signal strength to a corresponding pre-established signal strength threshold; obtaining contextual information by accessing sensor data from at least one sensor selected based on a result of the comparing; and determining, utilizing the contextual information, whether the portable communication device is transitioning from one of (i) an outdoor space to an indoor space and (ii) an indoor space to an outdoor space. In response to determining that the portable communication device is transitioning from one of (a) the indoor space to the outdoor space and (b) the outdoor space to the indoor space, the method includes configuring the portable communication device for operation within an end location to which the portable communication device is transitioning.

According to one or more embodiments, a portable communication device includes at least one communication mechanism that enables communicating with at least one of a location service, a RAN, and a small coverage area device or system. A first sensor generates sensor data that can be utilized as contextual information that may differentiate between an inside location versus outside location of the portable communication device. At least one processor is communicatively coupled to the first sensor and the at least one communication mechanism. An indoor/outdoor detection utility executes on the at least one processor and configures the portable communication device to: measure a signal strength and if applicable, a number of sources, of at least one of a location service signal, a RAN signal, and a small coverage area signal that is detectable within a current location of the portable communication device; compare the signal strength to a corresponding pre-established signal strength threshold; obtain contextual information by accessing sensor data from at least one sensor selected based on a result of the comparing; configure the portable communication device for operation within an outdoor space in response to determining that the portable communication device is transitioning from the indoor space to the outdoor space; and configure the portable device for operation within an indoor space in response to determining that the portable device is transitioning from the outdoor space to the indoor space.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof.

Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

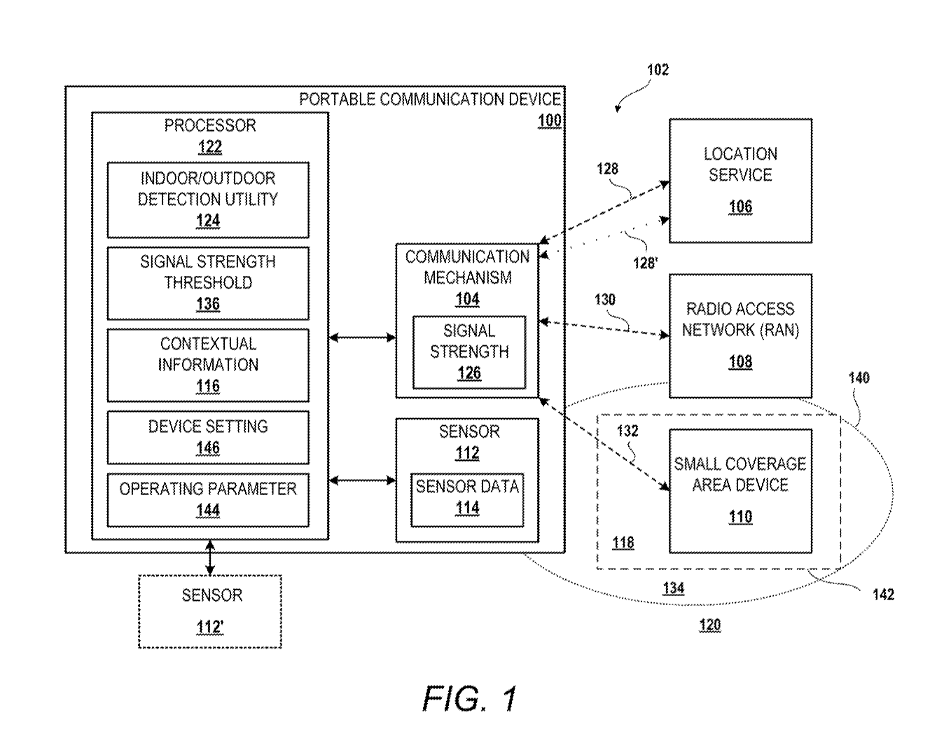

Turning now to FIG. 1, there is depicted a block diagram representation of an example portable communication device 100 within which several of the features of the disclosure can be implemented. The portable communication device 100 can be one of a host of different types of devices, including but not limited to, a mobile cellular phone or smart-phone, a laptop, a net-book, an ultra-book, a networked smart watch or networked sports/exercise watch, and/or a tablet computing device or similar device that can include wireless communication functionality. As a device supporting wireless communication, portable communication device 100 can be one of, and also be referred to as, a system, device, subscriber unit, subscriber station, mobile station (MS), mobile, mobile device, remote station, remote terminal, user terminal, terminal, communication device, user agent, user device, cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. These various devices all provide and/or include the necessary hardware and software to support the various wireless or wired communication functions as part of a communication system 102.

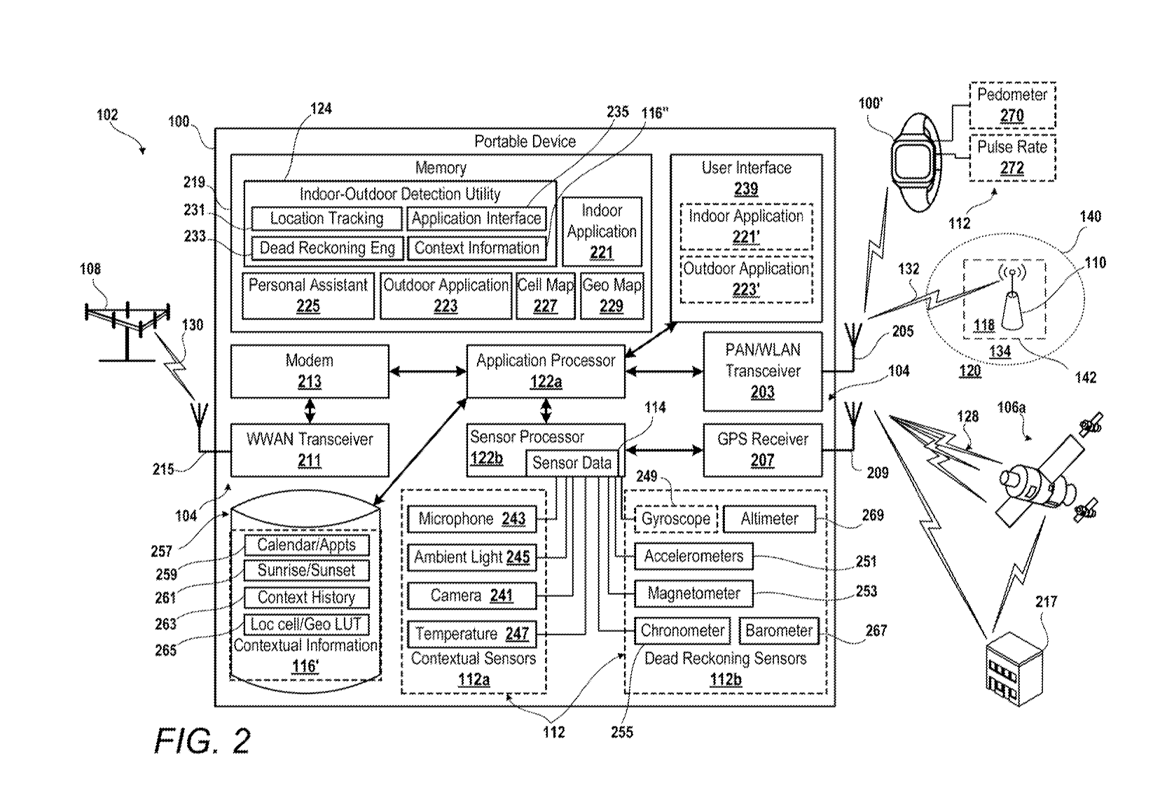

According to the general illustration, the portable communication device 100 is a processing device having at least one communication mechanism 104 that enables communicating with at least one of a location service 106, a RAN 108, and a small coverage area device 110. At least one sensor 112 generates sensor data 114 that can be utilized as contextual information 116 that may be used to assist in differentiating between an indoor space 118 versus an outdoor space 120 of the portable communication device 100. The at least one sensor 112 can be on-device, i.e., commonly housed within the portable communication device 100, or can optionally be external to (see 112′ depicted in phantom), but moving with the portable communication device 100. As an example of the external sensor 112′, the sensor can be an accessory device worn or carried by the user (see, for example, 100′, FIG. 2) and which can provide additional sensed or detected data. The external sensor 112′ is not integral to the handset itself. In one alternate embodiment, sensor data can be received from a remote external sensor 112′ that is completely separate from portable communication device 100 and which communicates sensed data or information to portable communication device 100 via an external wired or wireless communication medium. For simplicity in the description of the disclosure, the various possible types of sensors can be generally referenced as sensor 112 or at least one sensor 112. At least one processor 122 is communicatively coupled to the at least one sensor 112 and the at least one communication mechanism 104. An indoor/outdoor detection utility 124 executes on the at least one processor 122 and configures the portable communication device 100 to:

(a) measure a signal strength 126 of at least one of a location service signal 128, a RAN signal 130, and a small coverage area signal 132 that is detectable within a current location 134 of the portable communication device 100, wherein signal strength 126 can be a magnitude measurement of an individual signal or of each of a minimum number of detectable signals 128′ from multiple source transmission system (e.g., GNSS satellites);

(b) compare the signal strength 126 to a corresponding pre-established signal strength threshold 136 and where applicable, compare the number of signal sources to a threshold minimum number required for a clear signal (e.g., with GNSS satellites whose visibility to the portable communication device 100 can vary based on the portable communication device being indoors or outdoors);

(c) obtain contextual information 116 by accessing sensor data 114 from at least one sensor 112 selected based on a result of the comparing;

(d) determine, utilizing the contextual information 116, whether the portable communication device 100 is transitioning between outdoor space and indoor space, i.e. from one of (i) an outdoor space 120 to an indoor space 118 and (ii) an indoor space 118 to an outdoor space 120; and

(e) in response to determining that the portable communication device 100 is transitioning from one of (a) the indoor space 118 to the outdoor space 120 and (b) the outdoor space 120 to the indoor space 118, configure the portable communication device 100 for operation within an end location (outdoor space 120, indoor space 118, respectively) to which the portable communication device 100 is transitioning. For example, adjustments can be made to at least one of (i) operating parameters 144 and (ii) device settings 146.

For example, the small coverage area device 110 provides cellular or wireless fidelity (WiFi) or wireless broadband service to a small coverage area 140 generally intended to be limited to at least a portion of an interior space within a structure 142. The small coverage area 140 can also extend into the outdoor space 120 as well as the indoor space 118. Thus, there can be an ambiguous state in which a portable communication device 100 can be in the outdoor space 120 yet be within the small coverage area 140. As such, a transition between indoor space 118 and outdoor space 120 can result in an abrupt change in availability of service. Generally, the small coverage area device 110 has a strong signal within the indoor space 118 and a rapidly diminishing signal outside of the structure 142 surrounding the indoor space 118, i.e., within the outdoor space 120. Conversely, the location service 106 and RAN 108 each has a relatively strong signal outside of the structure 142 in the outdoor space 120 and have weaker signal within the structure 142 in the indoor space 118. Strength of the location service 106 can also be a function of a number of visible or receivable satellite signals of a GNSS at a higher Carrier-to-Noise (C/No) ratio in the outdoor space 120 as compared to the indoor space 118. The current location 134 is depicted in an illustrative transitional area wherein all the location service 106, the RAN 108, and small coverage area device 110 are accessible to the portable communication device 100.

In FIG. 2, there is depicted an example communication system 102 that is capable of simultaneously supporting wireless multiple-access communication for multiple wireless terminals such as portable communication device 100. The portable communication device 100 includes the hardware and software to support the various wireless or wired communication functions as part of a communication system 102. The portable communication device 100 can be a unitary device or an apparatus carried by an individual or vehicle having components in wired or wireless communication, such as a depicted multifunction, networked watch 100′ that performs some or all functions of communication and sensing.

The communication mechanism 104 of the portable communication device 100 can be a Personal Access Network (PAN) or Wireless Local Access Network (WLAN) transceiver 203 that transmits and receives over an antenna 205. In addition, for purposes of the disclosure, the communication mechanism 104 is defined to include a GPS receiver 207 that receives GPS satellite signals over a GPS antenna 209. The process by which the GPS receiver 207 receives a GPS signal that is transmitted from a remote satellite is occasionally referenced as a “communication”, insofar as GPS signal receipt involves one form of wireless signal propagation or communication. Alternatively or in addition, the communication mechanism 104 can be a Wireless Wide Area Network (WWAN) transceiver 211 that communicates data packets encoded or decoded by a modem 213 via an antenna 215 to RAN 108. For clarity, three antennas 205, 209, 215 are depicted; however, certain embodiments can switch access to an antenna for non-simultaneous communications or for selecting an appropriate antenna gain, or can share an antenna capable of multiple frequency band transmission and reception, or can use multiple antennas for purposes such as spatial diversity.

The communication mechanism 104 can communicate, for example, by using the PAN/WLAN transceiver 203 with the small coverage area device 110 that utilizes associated communication protocols. A PAN/WLAN transceiver 203 is not necessarily limited to any particular protocol, and instead may encompass any relatively short range or limited area wireless communication link. Examples of PAN protocols which may be used in the various embodiments include Bluetooth®, IEEE 802.15.4, and Zigbee® wireless communication protocols and standards. Another exemplary low power radio technology protocol is the ANT protocol, ANT+ (or ANT Plus) protocol, etc. ANT+ protocol is an interoperability function that can be added to the base ANT protocol, which is a proprietary wireless sensor network technology. ANT+ is primarily designed for collection and transfer of sensor data, to manageable units of various types. The ANT+ protocol radio can be used for data-transfer for a number of devices such as heart rate monitors, speed sensors, cadence sensors, foot pods, power meters, activity monitors, calorimeters, body mass index measuring devices, blood pressure monitors, blood glucose meters, pulse oximeters, positions tracking, short range homing beacons (e.g., disc golf, geo-caching), weight measuring devices, control of music players, temperature sensors, etc. For example, the multifunction networked, watch 100′ can have a pedometer 270 and a pulse rate sensor 272. In addition to these PAN protocols, wireless proximity-limited communication links may be established using other close range communication media, including for example radio frequency identification (RFID) tag and the IrDA (Infrared Data Association) protocols. Also, other close range wireless protocols and standards may be developed and may be used in the various embodiments in the same manner as described herein. Further, longer range wireless communication protocols may be used with modifications or additions to limit their effective range to the vicinity of the portable communication device 100. For example, WiFi and WiMax wireless communication protocols could also be used in combination with range-limiting features. For example, the power of miniaturized sensor transmitters (multifunction networked watch 100′) may be limited. Thus, either or both of the WWAN transceiver 211 and PAN/WLAN transceiver 203 can function at least during certain intervals as a PAN transceiver, although using a communication protocol typically capable of and used for a greater range. As another example, round-trip communication delay limits may be imposed such that the on-device or on-vehicle communication links can only be established if the round trip of such signals is less than a threshold set to reject signals sent from more than a dozen feet or so, which may be as short as two to three feet separation.

Alternatively or in addition, the communication mechanism 104 can communicate by using the WWAN transceiver 203 with the small coverage area device 110, such as a cellular femtocell. To supplement conventional mobile phone network base stations (commonly referred to as macrocell base stations, NodeBs, etc.), additional small-coverage base stations may be deployed to provide more robust wireless coverage for the wireless terminals. These small-coverage base stations may be commonly referred to as access point base stations, Home NodeBs, femto access points, femtocells, etc., and may be deployed for incremental capacity growth, richer user experience, in-building coverage, or the like. Typically, such small-coverage base stations are connected to the Internet and the mobile operator's network via a broadband connection, such as a digital subscriber line (DSL) router, cable or other modem, etc. Small-coverage base stations may also provide additional or enhanced services (e.g., increased bandwidth, unlimited access, access to other devices, etc.) to one or more wireless terminals.

The techniques described herein may be used for various wireless communication networks that operate according to, but not limited to, any one or more of the OMA (Open Mobile Alliance), 3GPP (3rd Generation Partnership Project), 3GPP2 (3rd Generation Partnership Project 2), IEEE (Institute of Electrical and Electronics Engineers) 802.xx, and WiMAX Forum standards. The terms “networks” and “systems” are often used interchangeably. Such communication networks can be Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network may implement a radio technology such as Universal Terrestrial Radio Access (UTRA), CDMA 2000, etc. UTRA includes Wideband-CDMA (W-CDMA) and time division synchronous code division multiple access (TD-SCDMA). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from the 3GPP organization. CDMA2000 is described in documents from the 3GPP2 organization. These various radio technologies and standards are known in the art.

Location service 106 (FIG. 1) can be provided by a Global Navigation Satellite System (GNSS), such as Global Positioning System (GPS), Globalnaya navigatsionnaya sputnikovaya sistema (GLONASS), GALILEO or BeiDou Navigation Satellite System (BDS). In the example portable device 100, location service 106 is provided by GPS 106a. Alternatively or in addition, location service 106 can be provided by triangulating from one or more RANs 108. Alternatively or in addition, location service 106 can be provided by “sniffing” of small coverage area devices 110 such as one or more wireless access points, femtocells, relays, etc. The location service 106, such as GPS 106a, can be more accurate when in the outdoor space 120. However, in some instances the location service 106 can be less accurate or even unavailable when in the outdoor space 120, such as when in an urban canyon or an obstruction 217 creates a multipath error.

Referring now to the specific component makeup and the associated functionality of the presented components, portable communication device 100 can include an application processor 122a, which connects via a plurality of bus interconnects (illustrated by the bi-directional arrows) to a plurality of functional components of portable communication device 100. The application processor 122a controls the communication, image capture, user interface, and other functions and/or operations of portable communication device 100. These functions and/or operations thus include, but are not limited to, application data processing. A sensor processor 122b performs digital signal processing and provides signal interfaces to sensors 112. The present innovation can be implemented using hardware component equivalents such as special purpose hardware, dedicated processors, general purpose computers, microprocessor-based computers, micro-controllers, optical computers, analog computers, dedicated processors and/or dedicated hard wired logic. Application processor 122a and sensor processor 122b can include separate programmable microprocessors or can both be integrated into a single processing device, in some embodiments.

Connected to application processor 122a is memory 219, which can include volatile memory and/or non-volatile memory. Moreover, an embodiment can be implemented as a computer-readable storage device having computer readable code stored thereon for programming a computer (e.g., comprising a processor) to perform a method as described and claimed herein.

One or more executable applications can be stored within memory for execution by application processor 122a. For example, memory 219 is illustrated as containing the indoor/outdoor detection utility 124. Memory 219 also can contain an indoor application 221, an outdoor application 223, a personal assistant utility 225, a cell mapping utility 227, and a geographic map utility 229. The indoor/outdoor detection utility 124 can assist the other applications and utilities in memory 219 by detecting being indoor or outdoor and by responding with appropriate location services. For example, the indoor/outdoor detection utility 124 can include a location tracking component 231 that can use indoor and outdoor location services. An example of indoor location services can be a dead reckoning engine 233. Yet another example of indoor location services that can be utilized is WiFi tri-lateration. The indoor/outdoor detection utility 124 can utilize an application interface 235 to selectively provide indoor location service or outdoor location service to the indoor and outdoor applications 221, 223.

The indoor/outdoor detection utility 124 can also utilize outdoor location services such as GPS, which allows the location of portable communication device 100 to be pin-pointed when signals from multiple GPS satellites are received by the GPS receiver 207. Two notable weak points with the use of GPS are the inability to determine a position when not receiving signals from more than one satellite (due to shielding by buildings or geographic features or improper antenna orientation) and use of more power consuming electronics. Another method of locating a portable communication device 100, such as a mobile phone, is by using fixed cell phone towers (cell tower triangulation), provided that signals can be received by those towers. A third method of locating a portable communication device 100 is by using a fixed array of radio frequency transceivers (integrated receivers and transmitters) distributed over a specific area to form a WLAN to relay signals wirelessly from the portable communication device 100 to a specific point, such as to a monitoring center or a gateway to the Internet, which in turn transmits the signal to a remote monitoring center. Then, by using either time of arrival or signal strength of a portable communication device 100 reaching a distributed transceiver, the location of the portable communication device 100 can be determined. Whatever, the outdoor location service that is employed, the indoor/outdoor detection utility 124 can still face an ambiguity of whether the device is indoor or outdoor or to what extent the device can or should attempt to receive outdoor location services.

The portable communication device 100 also comprises one or more input/output devices, depicted as a user interface device 239. For example, the indoor/outdoor detection utility 124 via application interface 235 can effect when or if an indoor or outdoor application 221, 223 executes, or how the application 221 or 223 executes, which execution is depicted on user interface device 239 respectively at 221′, 223′. It should be appreciated that the user interface device 239 can include one or more integral or distinct input devices, such as camera 241, microphone 243, touch screen and/or touch pad, keypad, and/or one or more integral or distinct output devices, such as display, speaker and others (not shown). Some input devices can also be used, or have a dedicated purpose, as contextual sensors 112a rather than for the user interface 239. Examples of other contextual sensors can be an ambient light sensor 245 and temperature sensor 247.

Indoor location services can be provided by dead reckoning engine 233 of indoor/outdoor detection utility 124. For instance, the sensor processor 122b can access sensor data 114 from dead reckoning sensors 112b depicted as gyroscope 249, accelerometers 251, magnetometer 253, chronometer 255, barometer 267, and altimeter 269. Whether indoor or outdoor, the dead reckoning engine 233 can provide a power saving mode or provide a fallback capability for location services.

This power saving mode for location services can include reducing reliance upon accurate but higher power consuming location services such as GPS. Real-time location-detection allows for many location-based applications such as store finding, transit routing, and advertisement targeting. In outdoor environments, GPS and cell-tower signals are typically used for detecting the location of mobile devices. However, cell-tower signals may not provide highly accurate or precise information about location, and GPS signals may not be available when satellite signals are obstructed, such as when the mobile device is in or near a building. Moreover, receiving and processing GPS signals may consume substantial energy and hence shorten battery duration. In addition to GPS sensors, some mobile devices are equipped with MEMS (Microelectromechanical Systems) sensors. MEMS sensors are typically very small mechanical devices which are driven by electricity. Various types of MEMS sensors include accelerometers, digital compasses, functional sensors, gyroscopes, and inertial modules. MEMS sensors can provide information about the movement of a mobile device. For example, they provide information about acceleration or the orientation of an object by generating electrical signals that correspond with dynamic forces, such as user movement of the device, or static forces such as gravity that act on the device.

Current technology may use either GPS, WiFi, such as Google® Location Services, or cell-tower signals to determine location. However, GPS signal receiving and processing consumes significant power, and cell-tower signals can provide prediction with only about 300-meter accuracy, on average, or 50-meter accuracy at best. Position information of a portable communication device 100 can be obtained with increased accuracy and reduced power consumption, such as by combining information from a GPS location sensor (GPS receiver 207) with information from MEMS devices such as an acceleration detectors (accelerometers 251) and a gyroscope 249 using statistical analysis techniques such as a Kalman filter to estimate the location of the device with greater accuracy, while using numerical methods such as the Newton-Raphson Method to minimize power consumption. Minimizing power consumption is possible because GPS signals sampled at a lower rate can conserve power, while GPS sampled at a lower rate and working together with MEMS devices can achieve the same level of location prediction accuracy as a GPS alone sampled at a higher rate. Alternatively or in addition, when the strength of the GPS signal is below a threshold (e.g., less than four (4) satellites can be successfully received and decoded,) the portable communication device can rely entirely upon on-device location services such as MEMS sensors or WiFi trilateration (dead reckoning sensors 112b).

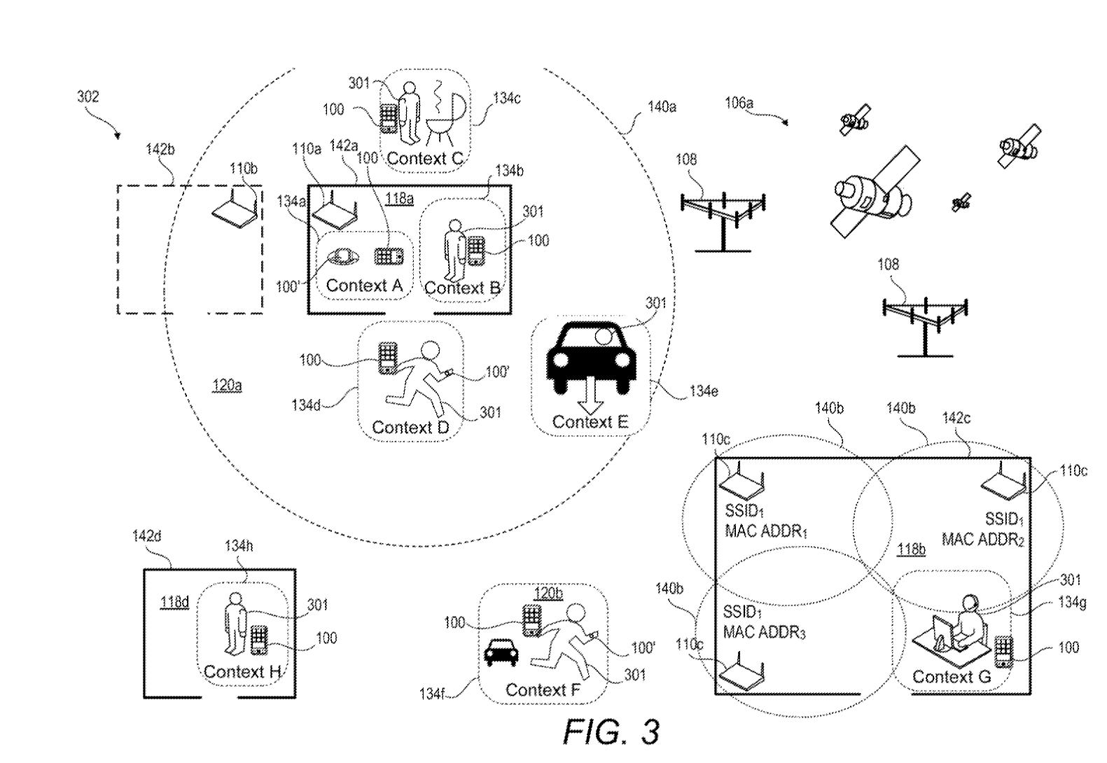

To reduce the ambiguity of being indoor or outdoor, the indoor/outdoor detection utility 124 can access contextual information 116 from the at least one sensor 112 or contextual information 116′ contained in a data storage device 257. Data storage device 257 can be any type of available storage device capable of storing one or more application software and data. It is further appreciated that in one or more alternate embodiments, the data storage device 257 can actually be remote storage and not an integral part of the portable communication device 100 itself The indoor/outdoor detection utility 124 can also derive contextual information 116″ from a combination of sensor data 114 and contextual information 116′. For example, the contextual information 116′ in the data storage device 257 can include personal information used by the personal assistant utility 225, depicted as calendar/appointment data 259. As another example, sunrise/sunset data 261 can be used with sensor data 114 from the chronometer 255 in conjunction with current location. Thereby, the indoor/outdoor detection utility 124 can determine whether it should be daylight when outdoors. Such contextual information 116″ can then be compared to sensor data 114 from the ambient light sensor 245. As an additional example, contextual information 116′ can include contextual history data 263. For example, past transitions from indoor to outdoor or outdoor to indoor at a particular location can be associated with certain sensor data 114, as discussed below with regard to FIG. 3. Identifying locations for such contextual history data 263 can be made with reference to a location cell data/geographic coordinate look up table (LUT) 265.

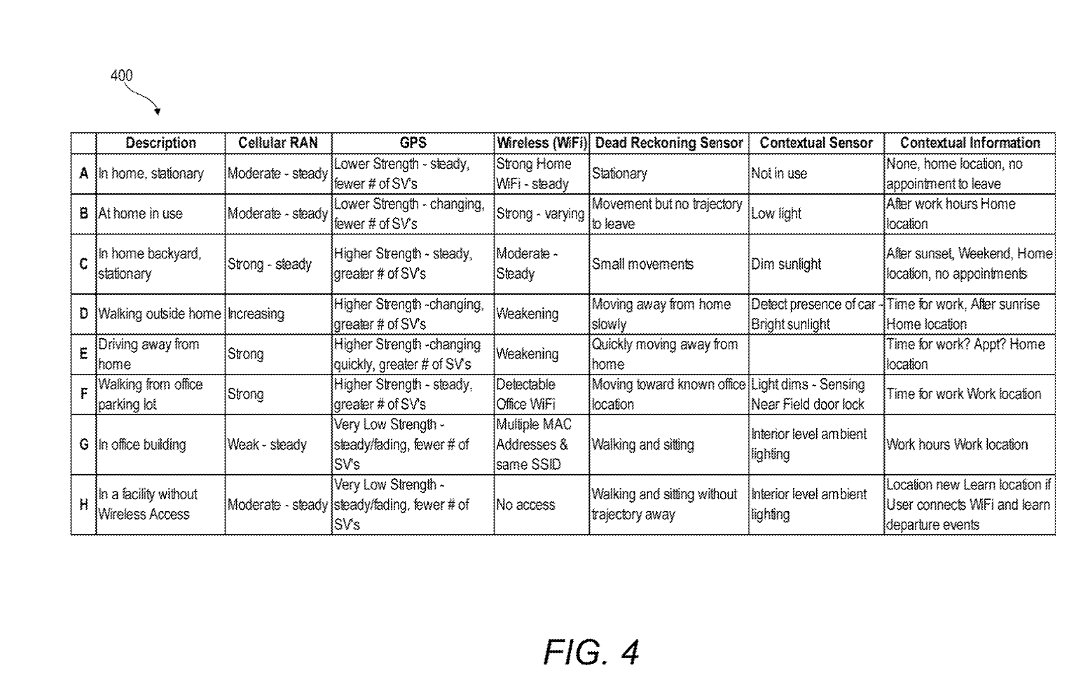

The associated functionality and/or usage of each of the software modules of the indoor/outdoor detection utility 124 will be described in greater detail within the descriptions which follow. In particular, the functionality associated with and/or provided by indoor/outdoor detection utility 124 is described in greater details with the description of FIGS. 4-10 and corresponding flow charts and other figures.

In FIG. 3, a portable communication device 100 associated with a user 301 traverses through an example communication system 302 with geographically and behaviorally distinct Contexts A-H that benefit from indoor/outdoor detection. In Context A, a current location 134a of the portable communication device 100 is within a structure 142a that is a residence of the user 301. A small coverage area device 110a is positioned within the structure 142a and services a small coverage area 140a within an indoor space 118a and a portion of an outdoor space 120a near the structure 142a. The portable communication device 100 that is augmented by the multifunction, networked watch 100′ can determine that no transition from indoor to outdoor is occurring based on one or more factors, such as the signal strength of the small coverage area device 110a being strong (e.g., not below a pre-established signal strength threshold). As another example, the portable communication device 100 can detect that it is stationary.

In Context B, the portable communication device 100 is in a current location 134b that is also within the structure 142a in the indoor space 118a but is being carried by user 301. The portable communication device 100 can respond to determining that the device 100 is in the indoor space 118a by implementing a power saving mode with respect to accessing outside location services, depicted as GPS 106a.

In Context C, the portable communication device 100 is in a current location 134c that is in outdoor space 120a outside of the structure 142a and is being carried by user 301. The portable communication device 100 can receive signals form another small coverage area device 110b in structure 142b, RAN 108 and GPS 106a; however, the portable communication device 100 can determine that the user 301 is not transitioning from indoors to outdoors. Rather, the portable communication device 100 is remaining within relative proximity to the small coverage area device 110a. For purposes of power savings and/or avoiding subscription costs to cellular services from RAN 108, the portable communication device 100 can remain in a power savings mode with respect to such outside services.

In Context D, the portable communication device 100 is in a current location 134d that is outside of the structure 142a, in the outdoor space 120a and is being carried by user 301. Sensor data from a multifunction, networked watch 100′ can indicate that motion or cardiovascular indications are that the user 301 is walking or running at a rate that indicates a transition from indoor to outdoor. The timing of a handover or of accessing more accurate outside location services can be based upon a determined rate of movement of the user 301.

In Context E, the portable communication device 100 is in a current location 134e that is outside of the structure 142a and is being carried by user 301 within a vehicle in the outdoor space 120a. The portable communication device 100 can detect being in a vehicle, can detect moving at rate indicative of a transition from indoor to outdoor, or can correlate a typical departure time for work, etc.

In Context F, the portable communication device 100 that is augmented by the multifunction, networked watch 100′ is in a current location 134f that is outside of the structure 142c and is being carried by user 301 leaving the vehicle within the outdoor space 120b. The current location 134f can be correlated with a known location for work based on historical contextual information or appointment data.

In Context G, the portable communication device 100 is in a current location 134g that is inside of the structure 142c and is being carried by user 301 in the inside space 118b. The structure 142c has portions serviced by respective small coverage area devices 110c each providing a respective small coverage area device 140b. The portable communication device 100 can detect being in an indoor space 118b confirmed by contextual information such as proximity to the small coverage area devices 110c or relative position to some subset of the small coverage area devices 110c, use of dead reckoning within the structure 142b, and/or reliance on time of day as compared to historical contextual information, etc.

In Context H, the portable communication device 100 is in a current location 134h that is inside of the structure 142d and is being carried by user 301 in the inside space 118d. This space can be one in which any small coverage area device 110 is unknown or unavailable. The portable communication device 100 can detect being indoor based upon inability to access GPS 106a due to lower signal strength and fewer visible satellites or RANs 108. Location services can enter a power saving mode based on relative movement within the structure 142d or upon lack of access to GPS 106a or RANs 108. The portable communication device 100 can learn new historical contextual information based upon any events sensed upon a transition between outdoor space and indoor space.

In FIG. 4, a data structure 400 for historical contextual information can be updated and maintained for the Contexts A-H (FIG. 3) with fields including, but not limited to, description, cellular RAN signal strength, GPS, small coverage area device (“wireless”) signal strength, dead reckoning sensor data, contextual sensor data, and derived contextual information. Within data structure 400, context A has a description of in home and stationary. This conclusion of the state of the device can be derived from the information in fields such as Cellular RAN that indicate that a signal from cellular RAN is moderate and steady. GPS can have a lower strength with a steady, fewer number of visible/receivable signals from satellite vehicles (SV). The small coverage area device signal (e.g., IEEE 802.11 protocol wireless or WiFi) is strong since the small coverage area device is close by. The structure blocks in the signal to a degree and the signal is steady since the device is not moving. Information in a field for a dead reckoning sensor or other location service can corroborate a stationary condition. In Context A, there is not another contextual sensor in use since the device may largely be in a power saving mode. Contextual information derived from time of day, day of week, and personal assistant utilities can indicate that there are no indications of a planned transition from the home location.

Context B can be described in the data structure 400 as at home with the device in use. Corroborating this conclusion is that again the cellular RAN signal is moderate and steady and the small coverage area signal is strong but varying as distance and indoor structures change reception. GPS can have a lower strength with changing, fewer number of visible/receivable signals from SVs. A dead reckoning sensor can indicate small movements in speed and direction. A contextual sensor for ambient lighting can indicate low lighting, indicative of being indoor. Contextual information can correlate with the physical sensors where the time of day is after sunset on a weekend, and the sensors indicate the device is at a home location with no appointments scheduled that would suggest a transition between indoor and outdoor.

Context C can be described in the data structure 400 as in home backyard and stationary. The cellular RAN signal can be steady and strong. GPS can have a higher strength with a steady, greater number of visible/receivable signals from SVs. The small coverage area signal is moderate and steady. The dead reckoning sensor or other location service indicates small movements that do not indicate a trajectory away from the house or into the house. A contextual sensor can detect dim sunlight that is corroborated by contextual information for time of day. In addition, the contextual information can provide no indications of appointments or work hours that would suggest departure.

In the data structure 400, context D can be described as walking outside of home. This conclusion can be corroborated by a cellular RAN signal increasing or remaining consistently strong whereas a small coverage area signal is weakening. GPS can have a higher strength with a changing, greater number of visible/receivable signals from SVs. A dead reckoning sensor or other location service can indicate pedestrian speed movement with a trajectory away from the home. Appointment information can confirm that the user is scheduled to be away from the home.

Context E can be described as driving away from home. This conclusion can be bolstered in the data structure 400 by a cellular RAN signal that is strong and a small coverage area signal that is weakening quickly. GPS can have a higher strength with a changing, quickly greater number of visible/receivable signals from SVs. A dead reckoning sensor or other location service can indicate that the device is moving quickly away from the home. Contextual information can corroborate a planned departure from a home location.

Context F can be described as walking away from the office parking lot. The data structure 400 supports this determination based on last location service indicating proximity to a work location, with dead reckoning sensors indicate movement toward the work location. GPS can have a higher strength with a steady, greater number of visible/receivable signals from SVs. The cellular RAN signal is strong. Small coverage area signals are detectable for known office WiFi signals. Contextual sensors can sense other transmitters such as a near field transmission for a badge-activated door lock. Another contextual sensor can be a change in ambient light consistent with moving indoor. Contextual information can further confirm approximate work hours.

Context G can be described as in the office building. In the specific example, the data structure 400 can support this determination based upon cellular RAN being a weak, steady signal with little reception inside of a multi-floor building. Alternatively, some indoor spaces can include internal antennas or repeaters that compensate for attenuation of cellular signals by building materials which the portable communication device can learn for a particular location. GPS can have a very low strength with a steady/fading number of visible/receivable signals from SVs. The presence of multiple MAC addresses and the same SSID can indicate a work space. Dead reckoning sensor can confirm walking and sitting within a space corresponding to the work location. Contextual sensors could confirm temperature and lighting consistent with a work space. Contextual information can further confirm work hours and work location.

Context H can be described as in a facility without small coverage area access, such as lacking IEEE 802.11 signal access. The data structure 400 can support this determination by tracking a cellular RAN signal that is moderate and steady, consistent with a small structure providing moderate interference with a cellular signal. GPS can have a very low strength with a steady/fading fewer number of visible/receivable signals from SVs. The wireless data can indicate no accessible small coverage area device. The dead reckoning sensor can indicate walking or sitting within the location without any trajectory away from the location. Contextual sensors can confirm indoor temperature and lighting. Contextual information can indicate that this location is new. Learning can occur for this new location, especially if the user enables connection to a small coverage area device.

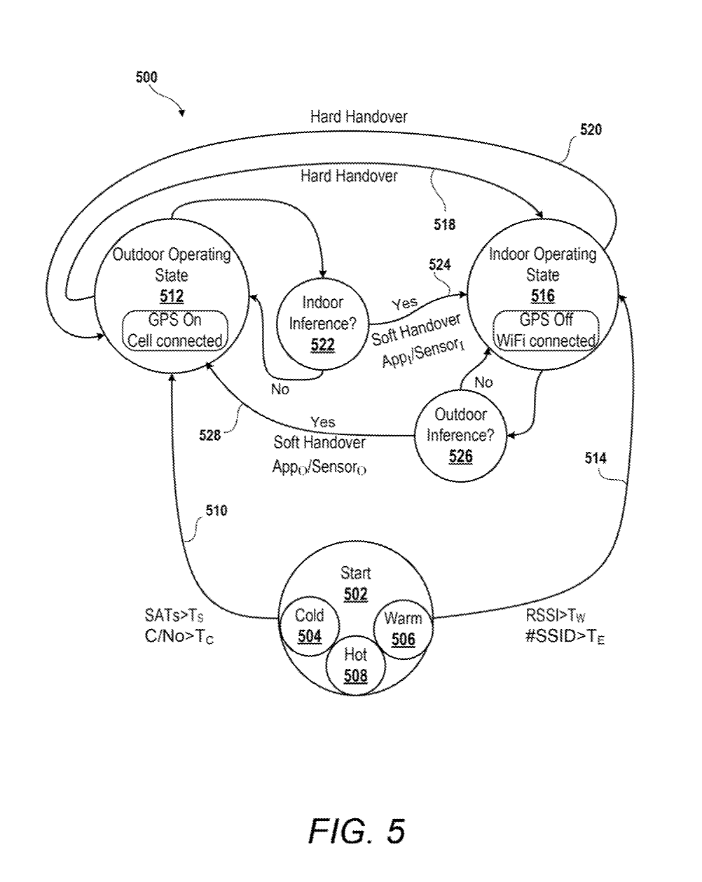

In FIG. 5, a state diagram 500 depicts how indoor/outdoor transition determinations can, in some instances, avoid a disruption in a data communication session by invoking a soft handover rather than a hard handover between different RANs. A hard handover occurs when the portable communication device has lost data service, which can interrupt an on-going data session or delay connecting to another host, as compared to a soft handover with service still available from a current host. Since transitions between indoor and outdoor can create abrupt changes in signal strength, the transition is early with regard to power thresholds currently sensed in order to ensure a soft handover. Alternatively or in addition, the indoor/outdoor determinations can, in some instances, invoke an appropriate indoor mode for power saving on location services usage. Thereby, portable communication device 100 (FIG. 1 or 2) can know when it is indoor versus outdoor and what the best network is in terms of accuracy and current consumption to update location. In addition, transitioning from an outside mode to an indoor mode can prompt seeding a dead-reckoning engine with a previously determined outside location. Alternatively, location determination when in an indoor location can be based upon WiFi RSSI/SSID tri-lateration or Google Location Service. In an exemplary embodiment, WiFi and dead-reckoning can be more accurate, particularly indoors when GPS is not available, as the WiFi location engine can be used to limit the growth in error of a dead-reckoning system. The indoor/outdoor determinations can use a GPS receiver, WiFi transceiver, sensor processor, contextual knowledge (schedule, email searches, social media interaction, etc.) in order to determine when entering/exiting home, office, coffee shop, train station, etc., and to take appropriate action.

For these and other reasons, indoor/outdoor determinations can be made as when best to switch a portable communication device between an indoor operating state and an outdoor operating state. The determination can generally relate to sensing whether the portable communication device is inside of a structure or outside of a structure. However, the operating state is not necessarily co-extensive with a physical state of being indoors or outdoors. For example, a small coverage area device such as a wireless access point or a femtocell can extend from an indoor space to an outdoor space. Economics of data subscription rates for service from a small coverage area device can generally encourage reverting to an indoor operating state when possible, even when technically in the outdoor space. However, determining that the portable communication device will soon transition can prompt an early switch thereby ensuring a soft handover rather than a hard handover with a resulting degradation in Quality of Service (QoS). Contextual information can indicate that an abrupt loss of service can occur when transitioning between indoor and outdoor whereas normal handover thresholds assume a gradual change in power levels.

An initial start state 502 is activated with power-up or wake-up of device 100. Accessing GPS can depend on whether in the GPS module is in a cold start 504, warm start 506, or hot start 508 condition. Cold start 504 is performed every time the GPS module is turned off without a backup power supply connected. During Cold Start 504, almanac and ephemeris data have to be downloaded first from the GPS satellites to GPS module before a position fix can be acquired. Assuming that a proper backup power source is provided, GPS module will perform Hot Start 508 if the GPS module is powered on any time within the two-hour time frame after GPS was previously turned off, as the ephemeris and almanac data is still stored inside the flash memory or a battery backed up Random Access Memory (RAM) of GPS module. Warm Start 506 is performed if the above module is started after the two-hour time frame but with almanac and ephemeris data at least partially available. In warm start 506, part of the satellite data of the GPS module has to be refreshed.

For example, a determination of whether the device 100 is in an outside or an indoor space in start state 502 is made, based upon the signal strength of the GPS signals and the number of visible satellites. As depicted by state transition 510, if the GPS module is activated from Cold Start 504, the device is determined to be located outside if one GPS satellite can be received with a carrier to noise ratio (C/No) of at least 26 db-Hz with at least three other GPS satellites being received with at least 23 dB-Hz. As further depicted by state transition 510, if the GPS module is activated from Warm Start 506, the device is determined to be located outside for the same conditions. As further depicted by state transition 510, if the GPS module is activated from Hot Start 508, the device can be determined to be located outside if three or more GPS satellites can be received with C/No of at least 23 db-Hz. In the outdoor operating state 512, the GPS is ON since GPS signals are generally available and often used for location services when outdoors due to their accuracy and independence from terrestrial navigation aids. It should be appreciated with benefit of the present disclosure that alternatively radio triangulation for location services can be performed when in the outdoor operating state 512. Alternatively, location services may not be required in the outdoor operating state 512. In an illustrative scenario, the portable communication device 100 is camped on or connected to a cellular RAN for data service. Otherwise if the criteria were not satisfied for determining an outdoor operating state 512, an inside state determination is found as depicted at 514. Being in the indoor operating state 516 in an illustrative scenario can entail turning off GPS for duration of a timer and connecting to a small coverage area device (e.g., WiFi).

Alternatively or in addition to determining signal strength for GPS signals, indoor/outdoor determination can commence with measuring signal strength for a small coverage area device 110 (FIG. 1) and comparing the measured signal strength to a signal strength threshold. A state transition, as depicted at 514, to the indoor operating state 516 can occur when RSSI Max (maximum Received Signal Strength Indication) is at least −60 dBm. The portable communication device 100 can be deemed to be indoors based upon an assumption regarding signal strength inside of a structure versus outside of the structure. It should be appreciated that this threshold is illustrative. In one or more embodiments, a determination can be made as to whether the number of detected SSIDs (Service Set Identification) is greater than five (5) and the SSID is repeated for multiple MAC (Medium Access Control) addresses. For example, a determination can be made whether an SSID is repeated for multiple MAC addresses on multiple frequencies because the default on many residential routers is on channel 6 with a default SSID. If the criteria for number of detected SSIDs is more than five (5) and the SSID is repeated for multiple MAC addresses, then portable communication device 100 can be deemed to be within an indoor enterprise such as a work facility.

The present disclosure addresses predicting a transition between an indoor space and an outdoor space. However, in certain instances a usage pattern is not well established for a particular user, a particular portable communication device 100, or a particular location. As such, learning opportunities occur when the portable communication device 100 fails to predict a transition with sufficient time to perform an early handover to ensure a soft handover for an on-going data session or incurs additional power consumption for remaining in a certain operating state inappropriate for the actual context. With an initial or preliminary determination of being in either an indoor operating state 516 or an outdoor operating state 512, the portable communication device 100 can utilize contextual information to resolve any ambiguity. For example, as depicted at 518, the portable communication device 100 encounters a hard handover from outdoor operating state 512 to indoor operating state 516 by going from cellular RAN to a small coverage area device. Any connected data session can be interrupted without the benefit of a contextual prediction of the transition to effect a soft handover. Instead, the hard handover can also entail loss of outside location service (GPS). In response, the portable communication device 100 can capture sensor data and contextual information associated with the hard handover for future opportunities at the current location. The portable communication device 100 can also seed a dead reckoning engine with the last location determined from the outside location service. Similarly, as depicted at 520 the portable communication device 100 can encounter a hard handover from indoor operating state 516 to the outdoor operating state 512 going from a small coverage area device to a cellular RAN.

By contrast, if the device is in outdoor operating state 512 then a repeated process can be performed, as depicted at 522, wherein an inference of a transition from outdoor to indoor is performed. If signal strength of the small coverage area device indicates an ambiguity of whether the device is transitioning indoor, then sensor data and contextual information is used to resolve the ambiguity. As shown by transition 524, if the transition is determined, then indoor operating state 516 is performed. Indoor operating state 516 can entail a soft handover of a data session before service is lost, as well as selecting or configuring applications and sensors for indoor operating state 516. If the device is in indoor operating state 516, then a repeated process can be performed wherein an inference of a transition from indoor to outdoor is performed as depicted at 526. For example, if signal strength of the small coverage area device indicates an ambiguity of whether transitioning outdoor, then sensor data and contextual information is used to resolve the ambiguity. If the device is transitioning states, as depicted at 528, then outdoor operating state 512 is activated. This transition from indoor operating state 516 to outdoor operating state 512 can entail an early handover of a data session before service is lost, as well selecting or configuring applications and sensors for outdoor operating state 512.

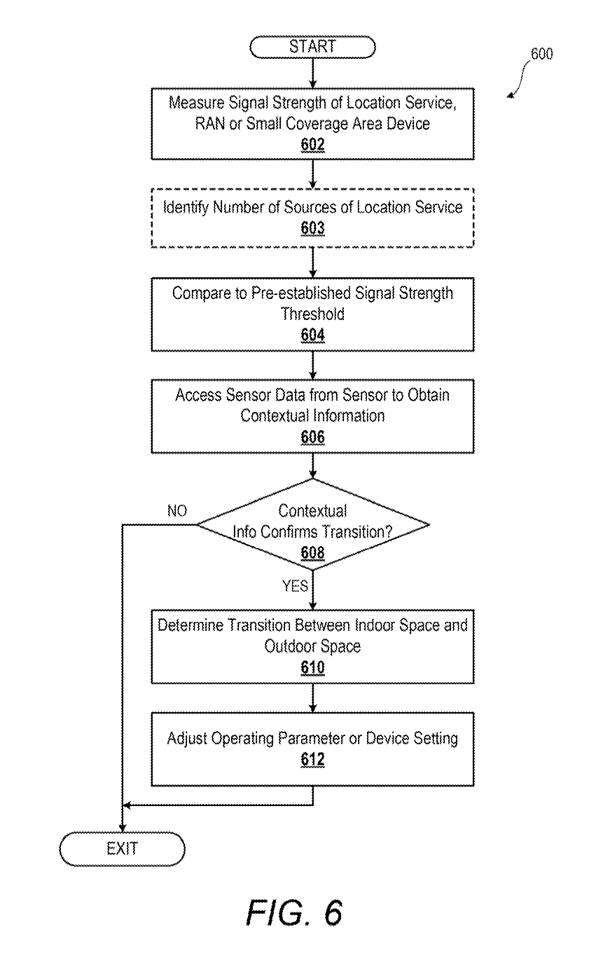

FIG. 6 illustrates a method 600 for determining indoor or outdoor location of a portable communication device 100 (FIG. 1). The communication mechanism 104 measures signal strength 126 of at least one of a location service signal 128, a RAN signal 130, and a small coverage area signal 132 that is detectable within a current 134 location of the portable communication device 100 (block 602). In an exemplary aspect for a location service, measuring signal strength includes determining a number of sources that are receivable or visible based on a respective magnitude of each detectable location service signal (block 603). The indoor/outdoor detection utility 124 compares the signal strength 126 to a corresponding pre-established signal strength threshold 136 (block 604). The indoor/outdoor detection utility 124 obtains contextual information 116 by accessing sensor data 114 from at least one sensor 112 selected based on a result of the comparing (block 606). A determination is made as to whether the contextual information 116 confirms a transition that is suggested by the comparison of the signal strength 126 to the pre-established signal strength threshold 136 (block 608). If a transition that is suggested by the comparison of the signal strength 126 to the pre-established signal strength threshold 136 is not confirmed utilizing the contextual information 116 in block 608, the method 600 exits. If a transition that is suggested by the comparison of the signal strength 126 to the pre-established signal strength threshold 136 is confirmed utilizing the contextual information 116 in block 608, then the indoor/outdoor detection utility 124 determines that the portable communication device 100 is transitioning from one of (i) an outdoor space 120 to an indoor space 118 and (ii) an indoor space 118 to an outdoor space 120 (block 610). In response to determining that the portable communication device 100 is transitioning from one of (a) the indoor space 118 to the outdoor space 120 and (b) the outdoor space 120 to the indoor space 118, the indoor/outdoor detection utility 124 configures the portable communication device 100 for operation within an end location (outdoor space 120, indoor space 118, respectively) to which the portable communication device 100 is transitioning (block 612).

For example, the indoor/outdoor detection utility 124 configures the portable communication device 100 by adjusting at least one of (i) one or more operating parameters and (ii) the one or more device settings. In a particular aspect, the method 600 includes performing at least one of: (a) performing a handoff between the small coverage area device and the radio access network; and (b) setting at least one signal transceiver of the portable communication device to a power saving mode.

As another example, the indoor/outdoor detection utility 124 configures the portable communication device 100 to access the sensor data 114 that includes motion data from an on-device sensor. The indoor/outdoor detection utility 124 determines that the portable communication device 100 is transitioning based upon identifying using pre-established transition data analysis that a trajectory of the motion data indicates one of transitioning from indoor-to-outdoor and outdoor-to-indoor. In a particular embodiment, the method 600 includes receiving location information of the portable communication device 100 from the location service supported by the portable communication device and which provides additional location information while the portable communication device is not located in an interior space. The additional location information can be substantially more accurate. The indoor/outdoor detection utility 124 seeds a dead reckoning engine 233 with the location information received. Alternatively or in addition, the indoor/outdoor detection utility 124 performs location service by an on-device location component by detecting one or more small coverage area devices.

According to one or more embodiments, the method 600 can further include accessing the sensor data by sensing an ambient condition comprising a change in an amount of illumination that is greater than pre-set illumination amount and that correlates to one of a daylight timeframe and a natural sunlight.

According to at least one embodiment, the method 600 can further include obtaining the contextual information by communicating with an accessory device connected to the portable communication device by a personal access network; and receiving the contextual information from a sensor of the accessory device via the personal access network. In at least one embodiment, the portable communication device 100 that can assist in resolving an ambiguity of being indoor or outdoor. The method 600 can include triggering a first sensor associated with the portable communication device to activate and provide first contextual information; receiving the first contextual information from the first sensor; and determining whether the first contextual information from the first sensor satisfies at least one inference rule indicating that the portable communication device is transitioning between indoor space and outdoor space. In response to the first contextual information not satisfying the at least one inference rule, the method 600 can further include triggering a second sensor to activate and provide second contextual information; receiving the second contextual information from the second sensor; and evaluating whether the second contextual information from the second sensor satisfies the at least one inference rule. The method 600 can then include sequentially activating subsequent sensors as necessary until a combination of contextual information supports a determination of one of: (a) a first state of remaining in an outdoor space; (b) a second state of remaining in an indoor space; (c) a third state of moving from an outdoor space to an indoor space; (d) a fourth state of moving from an indoor space to an outdoor space; and (e) an inconclusive result wherein available sensors comprising the first and second sensors have all been triggered without confirming a state.

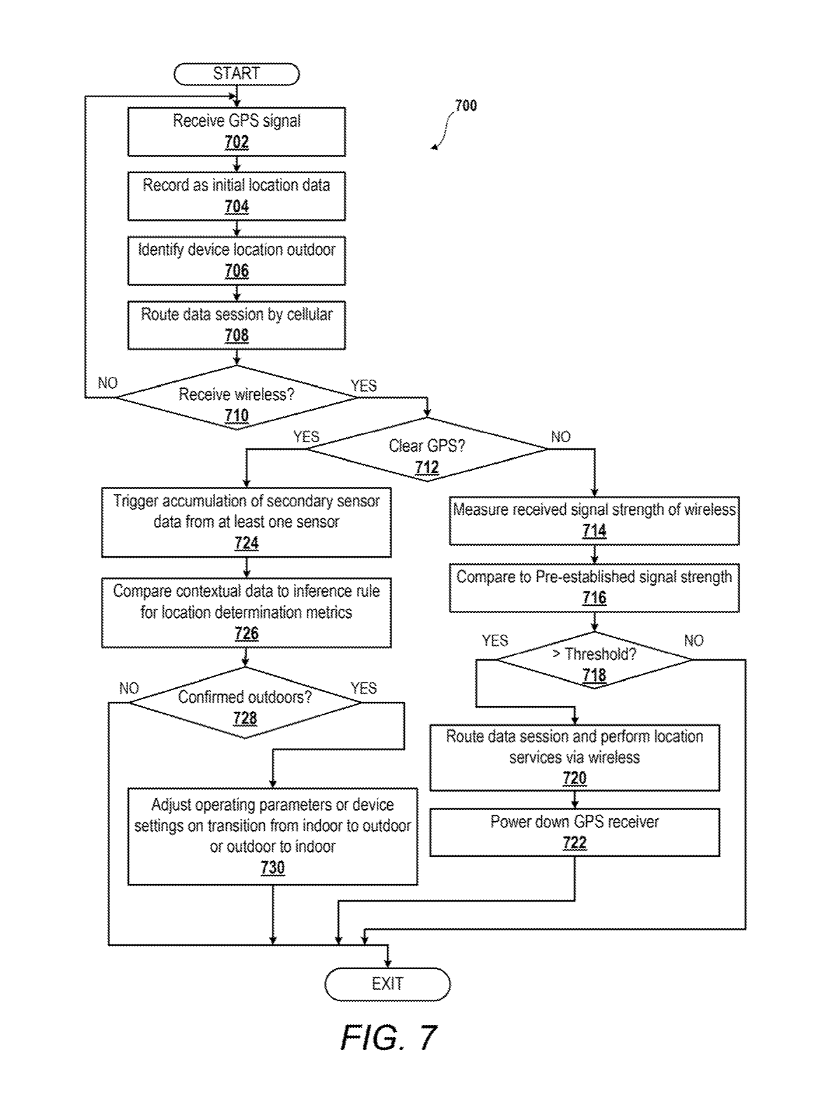

In FIG. 7, an example method 700 illustrates the portable communication device 100 (FIG. 1) using indoor and outdoor determinations according to at least one embodiment. In block 702, the portable communication device 100 receives GPS signal. In block 704, in response to receiving a GPS signal from an on-device GPS receiver, the portable communication device 100 records the initial location data obtained by performing a decoding and analysis of the received GPS signal. In decision block 706, the portable communication device 100 determines whether a device location as likely being outdoors based upon one or more factors including contextual sensors, signal strength readings, and historical contextual information. In block 708, the portable communication device 100 routes data session connections via a cellular radio access network.

Method 700 also includes determining at block 710 whether a small coverage area signal such as an IEEE 802.11 signal from a wireless access point is being received, and if so, determining at block 712 whether a clear GPS signal is being received. Determining that a clear GPS signal is being received can include receiving a sufficient number of signals from GNSS satellite vehicles that are above a threshold C/No level. In response to determining that a small coverage area signal such as an IEEE 802.11 signal from a wireless access point is received in block 710 and further in response to determining that a clear GPS signal is not being received in block 712, then the portable communication device 100 can evaluate whether a transition from outdoor to indoor is imminent. In particular, in block 714 the portable communication device 100 measures received signal strength of the wireless signal. In block 716, the portable communication device 100 compares the received signal strength for the wireless access point to a pre-established signal strength threshold above which the portable communication device is assumed to be indoors. In block 718, the portable communication device 100 determines whether the received signal strength is greater than the pre-established signal strength threshold. In block 720, the portable communication device 100, in response to received signal strength being above the pre-established signal strength threshold in block 718, routes data session connections and performing location determination via the wireless access point. In block 722, the portable communication device 100 powers down the on-device GPS receiver, which can entail reducing a rate or intervals of activation or being off for a substantial period. If in block 718 the signal strength threshold was not exceeded, then the method 700 exits at exit block.

Returning to block 710, if no wireless signal is received, the method 700 returns to block 702. However, in response to the determinations that a wireless signal is received and that sufficient GPS signals above a preset threshold C/No are also being received in block 712 (i.e., a clear GPS signal), then in block 724, the portable communication device 100 triggers an accumulation of secondary sensor data from at least one additional sensor that is communicatively coupled to a location processing component of the portable communication device. In block 726, the portable communication device 100 compares contextual data received from at least one additional sensor to at least one inference rule corresponding to location determination metrics, wherein the at least one inference rule resolves an ambiguity of whether the portable communication device 100 is indoor or outdoors. In block 728, the portable communication device 100 confirms that the portable communication device is indoors or outdoors based on the comparing. If not confirmed in block 728, then method 700 exits. In response to confirming in block 728, then the portable communication device 100 adjusts at least one of (i) one or more operating parameters and (ii) one or more device settings based on a transition of the portable communication device from one of outdoors-to-indoor and indoors-to-outdoors (block 730).

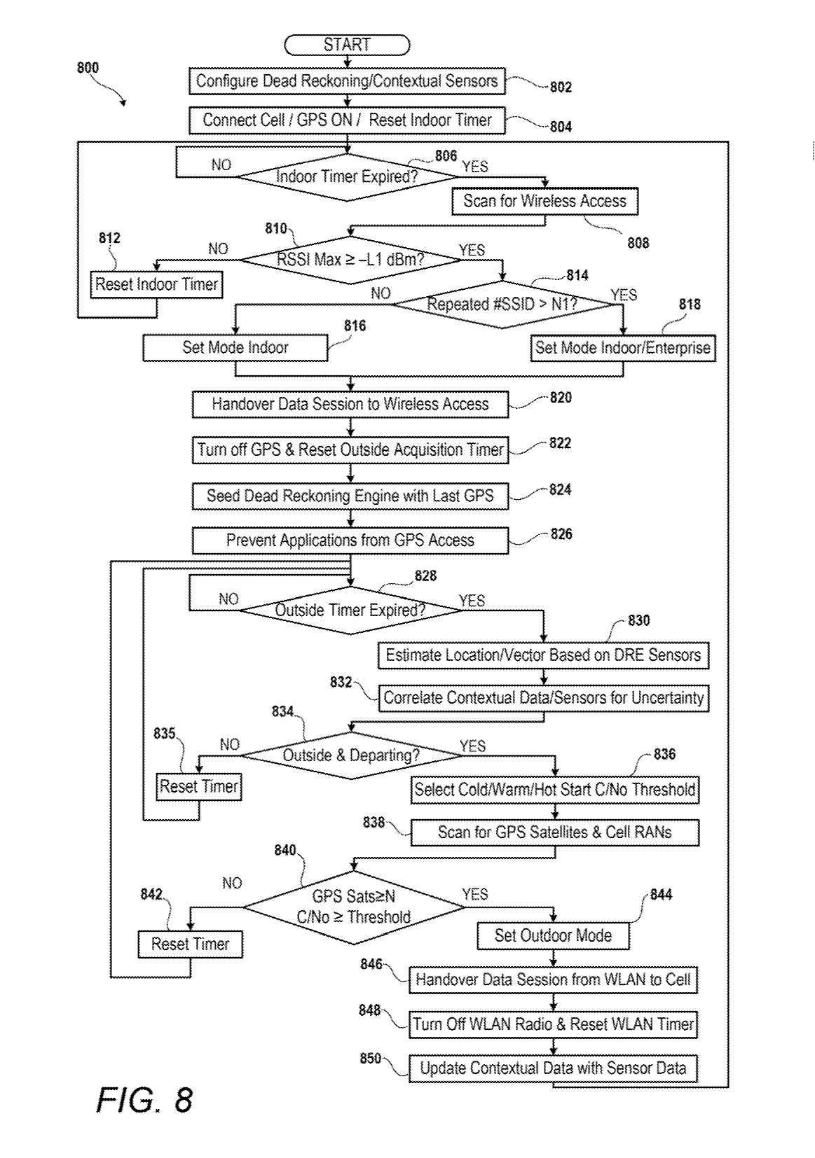

In FIG. 8, another example method 800 illustrates the portable communication device 100 (FIG. 1) using indoor and outdoor determinations according to at least one embodiment. In block 802, the portable communication device 100 configures dead reckoning and contextual sensors. For example, the last location update received from a location service can be seeded to the dead reckoning engine. Accessory devices can include contextual sensors. In block 804, the portable communication device 100 is in an illustrative state in which a data session is connected to a cellular RAN, the GPS receiver is active, and an indoor timer is reset.

In block 806, the portable communication device 100 waits for the indoor timer to expire. When the indoor timer expires in block 806 then in block 808, the portable communication device 100 scans for small coverage area device access (wireless access). A determination is made in block 810 whether RSSI max is at least a pre-established strength level, L1 (e.g., −60 dBm). If the RSSI max does not meet or exceed the pre-established strength level, L1, in block 810, then the indoor timer is reset in block 812 and the method 800 returns to block 806 to wait for the indoor timer to expire. If the RSSI Max is at least −60 dBm in block 810, then a further determination is made as to whether the number of SSIDs is greater than a pre-established number of SSIDs, N1, (e.g., five 5), in block 814. If the number of SSIDs is not greater than the pre-established number of SSID, N1, in block 814, then the mode is set to indoor in block 816. If the number of SSIDs is more than the pre-established number of SSIDs in block 814, then the mode is set to indoor/enterprise in block 818. In block 820, the portable communication device 100 hands over any data session to the wireless access. In block 822, the portable communication device 100 places the GPS in a low power state or suspends the receiver function of the GPS and resets an outside acquisition timer. In block 824, the portable communication device 100 seeds the dead reckoning engine with the last GPS location. In block 826, the portable communication device 100 prevents applications from attempting to turn on GPS receiver. Then, in block 828, the portable communication device 100 waits until the outside timer expires.

Following the timer expiring, in block 830, the portable communication device 100 estimates location or motion vector based on the dead reckoning engine (DRE) sensors or by WiFi sensing. In block 832, the portable communication device 100 correlates contextual data and/or sensors for determining a measure of certainty or uncertainty about whether now outside and departing. In block 834, the portable communication device 100 determines whether the uncertainty or ambiguity has been resolved that is outside and departing. If the uncertainty or ambiguity is not resolved in block 834, then the outside timer is reset in block 835 and the method 800 returns to block 828 to wait for the outside timer to expire.

If, in block 834, the device is determined to be outside and is leaving from the small coverage area device, then the portable communication device 100 selects the appropriate cold, warm, or hot start C/No thresholds in block 836. In block 838, the portable communication device 100 scans for GPS satellites and cellular RANs. In block 840, the portable communication device 100 determines whether the GPS number of satellites received and their corresponding signal strength exceeds the C/No thresholds. If the GPS number of satellites received is less than a threshold number “N” (e.g., 5) and their corresponding signal strength does not exceed the C/No threshold in block 840, then the outdoor timer is reset in block 842 and the method 800 returns to block 828 to wait for the outside timer to expire. If the GPS number of satellites received equal or greater to the threshold number “N” and their corresponding signal strength does exceed the C/No threshold in block 840, then the portable communication device 100 sets the mode as outdoor in block 844. In block 846, the portable communication device 100 hands over any active data sessions for wireless to cellular RAN. In block 848, the portable communication device 100 turns off the WLAN radio and resets the WLAN timer. In block 850, the portable communication device 100 updates contextual data with sensor data 114 that was detected up to the time of the transition.

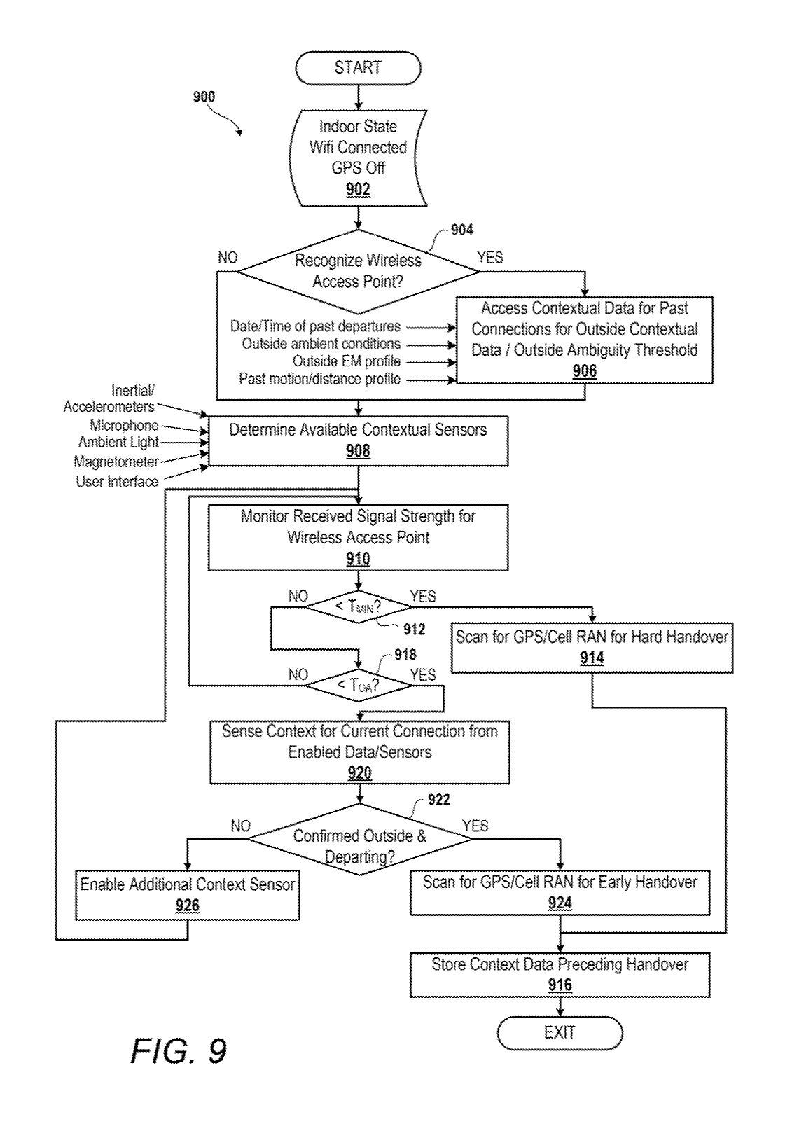

In FIG. 9, an additional example method 900 illustrates the portable communication device 100 (FIG. 1) using indoor and outdoor determinations according to at least one embodiment. As provided at block 902, the portable communication device 100 is in an indoor state with WiFi connected and GPS off. In block 904, the portable communication device 100 determines whether a small coverage area device (wireless access point) is recognized. If recognized in block 904, then in block 906 the portable communication device 100 accesses contextual data from past connections to the recognized wireless access point to assist in determining any transitions from indoor to outdoor or outdoor to indoor. For example, historical contextual information can be accessed such as the date, day of the week, and time of past departures/arrivals, outside ambient conditions, outside electromagnetic (EM) profile (e.g., nearby devices or broadcasts), and past motion/distance profiles.

For example, a departure path from a certain known small coverage area device can include a certain period of walking in a particular direction for a pre-set distance followed by driving in another particular direction at a greater rate than walking. When this pattern was encountered by the portable communication device in the past, the portable communication device departed from the small coverage area device. Thus, an inference can be created that future reoccurrences of this pattern indicate a likelihood of a necessary transition from an indoor operating state to an outdoor operating state. By contrast, the portable communication device can have had past occasions of staying in close proximity to a structure in an outdoor space and then returning to an inside space all the while remaining within the small coverage area device. Contextual data based upon motion data, time of day, etc., can reinforce an inference that a necessary transition from the indoor operating state to the outdoor operating state is not occurring when the pattern reoccurs.

In block 908, the portable communication device 100 determines what contextual sensors are available. This determination can be made with or without historical contextual information. Examples of sensors that can provide contextual information include inertial devices such as accelerometers, microphones, ambient light sensor, magnetometer, user interface devices, etc. For example, the portable communication device 100 can communicate with an electronically tethered wireless device that increases functionality. In addition, certain sensors may be available in certain models of portable communication device 100 but not others. Furthermore, certain sensors may be inoperative at a given time, like a magnetometer affected by an interfering object, an ambient light sensor obscured by a case, etc. In addition, the indoor/outdoor detection utility 124 can initially utilize sensors that are already activated for other purposes, reserving additional sensors for activation until needed to resolve an ambiguous indoor/outdoor situation.

With available sensors configured for the portable communication device 100 in block 908, the indoor/outdoor detection utility 124 monitors received signal strength for the wireless access point (block 910). The indoor/outdoor detection utility 124 compares the received signal strength against two thresholds first to see if the device is still receiving service and second to see if the device is in an ambiguous situation of receiving service but potentially transitioning out of the small coverage area. To that end, in block 912 a determination is made as to whether the received signal strength is below a minimum threshold (T_{MIN}). In response to the received signal strength being below T_{MIN} in block 912, a hard handover for any data session is required and the portable communication device scans for cellular RAN service (block 914). In the illustrative scenario, the portable communication device 100 is outside, following the device's departure from the small coverage area, and thus the portable communication device 100 also initiates scanning for outside location services such as GPS in block 914. Since the hard handover occurs prior to detecting an ambiguous indoor/outdoor situation, the portable communication device 100 can store contextual information/sensor data that preceded the hard handover in block 916 in order to enhance future operation of the indoor/outdoor detection utility 124. Then, method 900 exits.

Returning to block 912, in response to the received signal strength being at or above T_{MIN}, then a further determination is performed in block 918 as to whether the received signal strength is below a threshold for outside ambiguity (T_{OA}). If the received signal strength is not below the threshold for outside ambiguity in block 918, then the portable communication device 100 can be deemed to still be in an indoor space with the small coverage area device. The method 900 returns to block 910 to continue monitoring the received signal strength for the wireless access point. However, in response to determining that the received signal strength is less than the threshold for outside ambiguity in block 918, then the indoor/outdoor detection utility 124 of the portable communication device 100 senses contextual information regarding the current connection to the wireless access point by accessing an enabled sensor or by accessing contextual information and data (block 920). The indoor/outdoor detection utility 124 makes a determination as to whether the additional contextual information confirms a necessary transition from an indoor operating state to an outdoor operating state (block 922). The contextual data from the enabled sensor can indicate being outside of a structure in an outdoor state. Furthermore, the context data can further indicate that the portable communication device is not only departing from the inside space but is likely to depart from the small coverage area device (the wireless access point). In response to the contextual data providing confirmation of being outside and departing the small coverage area device in block 922, the portable communication device 100 scans for a cellular RAN for a soft handover, such as by performing an early handover wherein a source device and a target device coordinate to maintain a data session or connection via a backbone connection (block 924). Then, the contextual information or data that preceded the handover can be stored as in block 916 to enhance future indoor/outdoor detections. However, in response to not confirming being outside and departing in block 922, then the indoor/outdoor detection utility 124 can enable an additional contextual sensor in order to resolve the ambiguity (block 926). The method 900 then returns to block 910 to continue monitoring with the benefit of the additional sensor.

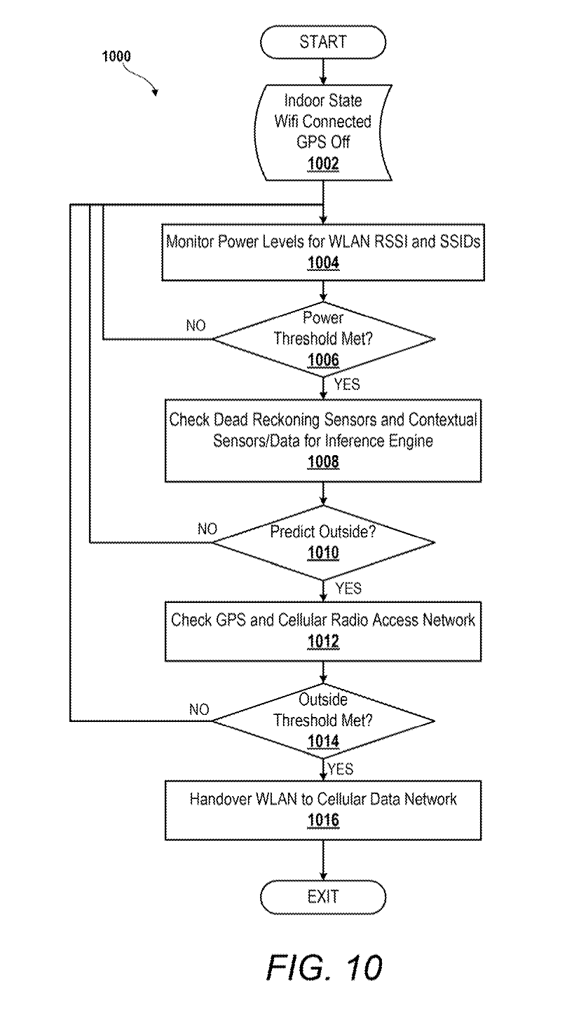

In FIG. 10, a further example method 1000 illustrates the portable communication device 100 (FIG. 1) using indoor and outdoor determinations according to at least one embodiment. In an illustrative scenario in block 1002, the portable communication device 100 is in an indoor state with WiFi connected and GPS off. In block 1004, the portable communication device 100 monitors power levels for WLAN RSSI and SSIDs. In block 1006, the portable communication device 100 determines whether a power threshold is met. In response to the power threshold not being met by the monitored WLAN RSSI and SSIDs in block 1006, then the method 1000 returns to block 1004 to continue monitoring. In response to the power threshold being met by the monitored WLAN RSSI and SSIDs in block 1006, then in block 1008 the portable communication device 100 checks dead reckoning sensors and contextual sensors/data for an inference engine (indoor/outdoor detection utility 124). Based upon this checking of the dead reckoning sensors and contextual sensors/data in block 1008, the indoor/outdoor detection utility 124 determines whether a confident prediction can be made that the portable communication device 100 is outside (block 1010). This prediction can involve, but is not necessarily limited to, comparing the amount of detected movement and direction of such movement with a threshold based upon pre-established movement data associated with the device being outdoors. Other predictive mechanisms are supported as well. If not able to predict being outside in block 1010, then the method 1000 returns to block 1004 to continue monitoring for WLAN RSSI and SSIDs. However, if able to predict being outside in block 1010, then in block 1012 the indoor/outdoor detection utility 124 of the portable communication device 100 checks for GPS and cellular RAN access. In response to this checking of the GPS and cellular RAN in block 1012, the indoor/outdoor detection utility 124 of the portable communication device 100 makes a determination of whether the GPS and/or cellular RAN signals meet a threshold for being outside (block 1014). If neither the GPS signals nor cellular RAN signals meet the threshold for being outside in block 1014, the method 1000 returns to block 1004 to continue monitoring WLAN RSSI and SSIDs. However, if either the GPS signals or the cellular RAN signals meet the threshold for being outside in block 1014, then in block 1016, the portable communication device 100 performs a handover from the WLAN to a cellular data network.

In each of the flow charts of FIGS. 6-10 presented herein, certain steps of the methods can be combined, performed simultaneously or in a different order, or perhaps omitted, without deviating from the spirit and scope of the described innovation. While the method steps are described and illustrated in a particular sequence, use of a specific sequence of steps is not meant to imply any limitations on the innovation. Changes may be made with regards to the sequence of steps without departing from the spirit or scope of the present innovation. Use of a particular sequence is therefore, not to be taken in a limiting sense, and the scope of the present innovation is defined only by the appended claims.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

Aspects of the present innovation are described below with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While the innovation has been described with reference to exemplary embodiments, it will be understood by those skilled in the art that various changes may be made and equivalents may be substituted for elements thereof without departing from the scope of the innovation. In addition, many modifications may be made to adapt a particular system, device or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description, but is not intended to be exhaustive or limited to the innovation in the form disclosed. Many modifications and variations will be apparent to those of ordinary skill in the art without departing from the scope and spirit of the innovation. The embodiment was chosen and described in order to best explain the principles of the innovation and the practical application, and to enable others of ordinary skill in the art to understand the innovation for various embodiments with various modifications as are suited to the particular use contemplated.

What is claimed is:

1. A method for determining indoor or outdoor location of a portable communication device, the method comprising:
measuring a signal strength of at least one of a location service signal, a radio access network (RAN) signal, and a small coverage area signal that is detectable within a current location of the portable communication device;
comparing the signal strength to a corresponding pre-established signal strength threshold;
obtaining contextual information by accessing sensor data from a first sensor selected based on a result of the comparing;
determining, utilizing the contextual information, whether the portable communication device is transitioning between an outdoor space and an indoor space;
configuring the portable communication device for an outdoor space in response to determining that the portable communication device is transitioning from the indoor space to the outdoor space; and
configuring the portable device for an indoor space in response to determining the portable device is transitioning from the outdoor space to the indoor space.

2. The method of claim 1, wherein configuring the portable communication device comprises adjusting at least one of (i) one or more operating parameters and (ii) one or more device settings.

3. The method of claim 2, wherein adjusting the at least one of (i) one or more operating parameters and (ii) one or more device settings comprises at least one of: (a) performing a handoff between a small coverage area device and a radio access network; and (b) setting at least one signal transceiver of the portable communication device to a power saving mode.

4. The method of claim 1, wherein:
accessing the sensor data comprises accessing motion data from an on-device motion sensor; and
determining whether the portable communication device is transitioning comprises identifying that a trajectory of the motion data indicates one of (i) transitioning from the indoor space to the outdoor space and (ii) transitioning from the outdoor space to the indoor space.

5. The method of claim 4, further comprising:
receiving location information of the portable communication device from a location service supported by the portable communication device and which provides additional location information while the portable communication device is not located in an interior space; and
seeding a dead reckoning engine with the location information received.

6. The method of claim 4, further comprising:
receiving location information of the portable communication device from a location service supported by the portable communication device and which provides additional location information while the portable communication device is not located in an interior space; and
in response to receiving the location information, performing location service by an on-device location component by detecting one or more small coverage area devices.

7. The method of claim 1, wherein accessing the sensor data comprises sensing an ambient condition comprising a temperature change that is greater than a pre-set temperature amount.

8. The method of claim 1, wherein accessing the sensor data comprises sensing an ambient condition comprising a change in an amount of illumination that is greater than pre-set illumination amount and that correlates to one of a daylight timeframe and a natural sunlight.

9. The method of claim 1, wherein obtaining the contextual information comprises:
communicating with an accessory device connected to the portable communication device by a personal access network; and
receiving the contextual information from a sensor of the accessory device via the personal access network.

10. The method of claim 1, further comprising:
triggering a first sensor associated with the portable communication device to activate and provide first contextual information;
receiving the first contextual information from the first sensor;
determining whether the first contextual information from the first sensor satisfies at least one inference rule indicating that the portable communication device is transitioning;
in response to the first contextual information not satisfying the at least one inference rule:
triggering a second sensor to activate and provide second contextual information;
receiving the second contextual information from the second sensor; and
evaluating whether the second contextual information from the second sensor satisfies the at least one inference rule; and
sequentially activating subsequent sensors as necessary until a combination of contextual information supports a determination of one of (a) a first state of remaining in an outdoor space; (b) a second state of remaining in an indoor space; (c) a third state of moving from an outdoor space to an indoor space; (d) a fourth state of moving from an indoor space to an outdoor space;
and (e) an inconclusive result wherein available sensors comprising the first and second sensors have all been triggered without confirming a state.

11. The method of claim 1, wherein:
measuring the signal strength of the location service signal comprises measuring signal strength of each of more than one location service signal from respective global navigation satellite system (GNSS) satellites; and
comparing the signal strength to the corresponding pre-established signal strength threshold comprises:
determining a number of the more than one location service signal that exceeds the pre-established signal strength threshold; and
comparing the number to a pre-established satellite number threshold.

12. A portable communication device, comprising:
at least one communication mechanism that enables communicating with at least one of a location service, a radio access network (RAN), and a small coverage area device;
a first sensor that generates sensor data that can be utilized as contextual information that may differentiate between an inside location versus outside location of the portable communication device;
at least one processor that is communicatively coupled to the at least one sensor and the at least one communication mechanism; and
an indoor/outdoor detection utility that executes on the at least one processor and configures the portable communication device to:
measure a signal strength of at least one of a location service signal, a RAN signal, and a small coverage area signal that is detectable within a current location of the portable communication device;
compare the signal strength to a corresponding pre-established signal strength threshold;
obtain contextual information by accessing sensor data from at least one sensor selected based on a result of the comparing;
determine, utilizing the contextual information, whether the portable communication device is transitioning between an outdoor space and an indoor space;
configure for an outdoor space when in response to determining that the portable communication device is transitioning from the indoor space to the outdoor space; and
configuring the portable device for an indoor space in response to determining the portable device is transitioning from the outdoor space to the indoor space.

13. The portable communication device of claim 12, wherein the indoor/outdoor detection utility configuring the portable communication device includes configuring the portable communication device to adjust at least one of (i) one or more operating parameters and (ii) one or more device settings.

14. The portable communication device of claim 13, wherein adjusting the at least one of (i) one or more operating parameters and (ii) one or more device settings comprises at least one of: (a) performing an handoff between the small coverage area device and the radio access network; and (b) setting at least one signal transceiver of the portable communication device to a power saving mode.

15. The portable communication device of claim 12, wherein:
accessing the sensor data comprises accessing motion data from an on-device motion sensor; and
determining whether the portable communication device is transitioning comprises identifying that a trajectory of the motion data indicates one of (i) transitioning from the indoor space to the outdoor space and (ii) transitioning from the outdoor space to the indoor space.

16. The portable communication device of claim 15, further comprising:
receiving location information of the portable communication device from the location service supported by the portable communication device and which provides additional location information while the portable communication device is not located in an interior space; and
seeding a dead reckoning engine with the location information received.

17. The portable communication device of claim 15, further comprising:
receiving location information of the portable communication device from a location service supported by the portable communication device and which provides additional location information while the portable communication device is not located in an interior space; and
in response to receiving the location information, performing location service by an on-device location component by detecting one or more small coverage area devices.

18. The portable communication device of claim 12, wherein accessing the sensor data comprises sensing an ambient condition comprising a temperature change that is greater than a pre-set temperature amount.

19. The portable communication device of claim 12, wherein accessing the sensor data comprises sensing an ambient condition comprising a change in an amount of illumination that is greater than pre-set illumination amount and that correlates to one of a daylight timeframe and a natural sunlight.

20. The portable communication device of claim 12, wherein obtaining the contextual information comprises:
communicating with an accessory device connected to the portable communication device by a personal access network; and
receiving the contextual information from a sensor of the accessory device via the personal access network.

21. The portable communication device of claim 12, further comprising:
triggering the first sensor associated with the portable communication device to activate and provide first contextual information;
receiving the first contextual information from the first sensor;
determining whether the first contextual information from the first sensor satisfies at least one inference rule indicating that the portable communication device is transitioning;
in response to the first contextual information not satisfying the at least one inference rule:
triggering a second sensor to activate and provide second contextual information;
receiving the second contextual information from the second sensor; and
evaluating whether the second contextual information from the second sensor satisfies the at least one inference rule; and
sequentially activating subsequent sensors as necessary until a combination of contextual information supports a determination of one of: (a) a first state of remaining in an outdoor space; (b) a second state of remaining in an indoor space; (c) a third state of moving from an outdoor space to an indoor space; (d) a fourth state of moving from an indoor space to an outdoor space;
and (e) an inconclusive result wherein available sensors comprising the first and second sensors have all been triggered without confirming a state.

22. The portable communication device of claim 12, wherein:
measuring the signal strength of the location service signal comprises measuring signal strength of each of more than one location service signal from respective global navigation satellite system (GNSS) satellites; and
comparing the signal strength to the corresponding pre-established signal strength threshold comprises:
determining a number of the more than one location service signal that exceeds the pre-established signal strength threshold; and
comparing the number to a pre-established satellite number threshold.
